(19) United States
(12) Patent Application Publication
(10) Pub. No.: US 2026/0102960 A1
(43) Pub. Date: Apr. 16, 2026

(54) TEMPERING DEVICE AND BLOWN FILM LINE WITH A TEMPERING DEVICE

(71) Applicant: Kdesign GmbH, Königswinter (DE)

(72) Inventors: Richard ZIMMERMANN, Königswinter (DE); Daniel LAMERS, Königswinter (DE)

(73) Assignee: Kdesign GmbH, Königswinter (DE)

(21) Appl. No.: 19/355,652

(22) Filed: Oct. 10, 2025

(30) Foreign Application Priority Data
Oct. 14, 2024 (EP) 24206521.7

(51) Int. Cl. B29C 48/90; B29C 48/00; B29C 48/10; B29L 23/00

(52) U.S. Cl. CPC B29C 48/907; B29C 48/0018; B29C 48/10; B29C 48/903; B29C 48/906; B29L 2023/001

(57) ABSTRACT

A tempering device for tempering a film tube extruded in a haul-off direction above a frost line includes: several guide segments distributed around a longitudinal axis parallel to the haul-off direction of the film tube and forming a central guide opening for guiding the film tube along the longitudinal axis, the guide segments being adjustable transversely to the longitudinal axis for adjusting the diameter of the guide opening; a guide roller for each guide segment, the guide roller being adjustable together with the guide segment and configured to guide the extruded film tube; and a nozzle section associated with the guide roller, which is adjustable together with the guide segment. The nozzle section has a blow-out nozzle for blowing out a tempering gas in the direction towards the longitudinal axis. The nozzle section is arranged relative to the longitudinal axis in at least partial radial overlap with the guide roller.

### CROSS-REFERENCE TO RELATED APPLICATIONS

This application claims priority to and the benefit of EP24206521.7 filed on October 14, 2024, the disclosure of which is incorporated herein by reference.

### FIELD

The present disclosure relates to a tempering device for controlling a temperature of a film tube extruded in a haul-off direction above a frost line. The disclosure also relates to a blown film line including such a tempering device.

### BACKGROUND

The statements in this section merely provide background information related to the present disclosure and may not constitute prior art.

DE 202023101698 U1 discloses a tempering device and a blown film line. In the tempering device shown there, a guide roller and a nozzle section are arranged one behind the other in a haul-off direction. The nozzle sections are designed in the form of blow-out beams that are attached to pivot arms. The guide rollers are also attached to the pivot arms.

DE 2357138 A1 shows a post-cooling device for blown films made of thermoplastics with at least one cooling air ring arranged beyond the frost line with air outlet openings directed towards the film tube, which consists of a plurality of individual blowing elements, each of which is pivotably connected to one another in pairs at their adjacent ends about axes running perpendicular to the longitudinal axis and can be adjusted radially in relation to the longitudinal axis. The post-cooling device is arranged on a calibration basket, by means of which the film tube is centered and guided.

EP 1491319 A1 describes a blown film line which comprises gas suction means surrounding the film tube downstream of the calibrating basket with essentially annularly arranged suction nozzles for extracting monomer-containing evaporations. Immediately above, i.e., downstream of the gas suction means, a post-tempering unit is arranged outside the film tube in the form of a further cooling gas ring, which is designed as a rigid ring with a fixed, unchangeable internal diameter for the film tube to pass through.

In blown film production, thermoplastic material is pressed by an extruder into a blow head with a ring die or channel, forming a film tube that is pulled upwards. The hot film tube is exposed to an internal overpressure and is blown with cooling gas from the outside and possibly also from the inside in an essentially annular shape immediately after exiting the ring nozzle, thereby cooling it down. After a phase of expansion of the film tube, the thermoplastic material solidifies to a large extent as it exits the ring die, after which the film tube essentially retains its diameter. The point of solidification is referred to as the freezing point or frost line. After solidification, the film tube is fed lengthwise via a calibrating basket and a collapsing unit and is squeezed and hauled off as a flat tube by a haul-off unit. The calibration basket is already above the frost line. The diameter of the film tube and thus the subsequent film width can be changed and is varied by the internal overpressure in the film tube and the setting of the adjustable calibration basket.

The film tube, which is still relatively warm, can be cooled with the additional cooling gas ring before it enters the collapsing unit, so that there is less risk of the film layers blocking (sticking to each other) in the haul-off unit after the film tube has been fold-ed. This means that the film layers cannot be separated from each other, or only with difficulty, when winding onto several coils or during subsequent processing.

When feeding the film tube into the collapsing unit and the haul-off unit, there is a risk with known blown film lines of this type that the film tube is not fed centrally to the collapsing unit and the haul-off unit. In addition, this non-centric position of the film tube can change constantly during production. This can lead to creases in the folded film tube or an edge offset, for example.

During the extrusion of film tubes, certain recipes and products result in so-called flatness errors in the film produced. Such flatness errors are, for example, waves with any distribution, sagging in the area of the edges and so-called camber.

Such errors are clearly visible when the film is unrolled from the finished coil and rolled out on the floor without tension. Put simply, flatness errors are local length deviations of individual film areas across the web width.

These faults can often be detected visually in the film web under tension on the way from the haul-off to the winder or within the winder.

In the area of the still round film tube, heating tunnel devices are known which heat the film tube again above the frost line using infrared radiant heaters arranged in a fixed diameter in order to improve the flatness quality of the film which is later collapsed. This utilizes the effect that uneven stress distributions due to different molecular orientations on the circumference of the film tube and the resulting local length differences are reduced again by reheating, so that flatness errors in the collapsed film are significantly reduced or completely prevented.

The uneven stress distributions are mainly caused by flow effects in the extrusion die of the blow head, for example by a flow channel design that does not optimally match the raw material, by an unsuitable heating profile of the extrusion die, or by an uneven circumferential temperature distribution and/or circumferential volume distribution of the melt inside and at the outlet from the extrusion die.

In addition, a calibration basket that is set at a height that does not match the frost line of the film tube, excessive contact pressure (filling level) in the calibration basket or a calibration basket that is slightly off-center in relation to the extrusion die can also cause flatness errors.

A disadvantage of the heating tunnel devices is the rigid arrangement of the radiant heaters, because a wide range of different bubble diameters is usually produced. The variable distance between the film and the heating tunnel is an additional influential parameter alongside the actual production parameters.

### SUMMARY

This section provides a general summary of the disclosure and is not a comprehensive disclosure of its full scope or all of its features.

According to an embodiment, a tempering device for controlling the temperature of a film tube extruded in a haul-off direction above a frost line is provided. The tempering device includes several guide segments which are distributed around a longitudinal axis arranged parallel to the haul-off direction of the film tube and form a central guide opening for guiding the film tube along the longitudinal axis. The guide segments are adjustable transversely to the longitudinal axis for adjusting the diameter of the guide opening. Furthermore, the tempering device has a guide roller for each guide segment. The guide roller is adjustable together with the guide segment and is intended to guide the extruded film tube. A nozzle section assigned to the guide roller is adjustable together with the guide segment. The nozzle section has a blow-out nozzle which is configured to blow out a tempering gas in the direction towards the longitudinal axis. The nozzle section is arranged, to the longitudinal axis, in at least partial radial overlap with the guide roller.

The nozzle section thus covers or overlaps the guide roller at least partially when viewed in a radial direction. This overlapping arrangement of the nozzle sections and the guide rollers in the longitudinal direction reduces the overall height of the tempering device in the direction of the longitudinal axis. In this way, two functions are realized on a very small overall height, namely the tempering of the film tube on the one hand and the guiding of the film tube on the other. The tempering device is therefore significantly more compact than conventional tempering devices.

This is of particular importance as the installation space in the haul-off direction, i.e. in the direction of the longitudinal axis, is often limited by low hall heights or other system components, for example. A low overall height of the entire blown film line can also be desirable for other reasons, as this can have a positive effect on the costs of a system, for example.

On the other hand, it is possible to arrange additional sensors or system components in the installation space gained compared to conventional blown film lines without reducing the overall height of the blown film line, or with a smaller reduction in height than is theoretically possible. It would also be possible to use the installation space gained for an arrangement of further guide levels with additional guide segments in order to increase the tempering performance compared to conventional tempering units.

Efficient and variable post-tempering is made possible by the fact that the guide segments can be adjusted transversely to the longitudinal axis to set the diameter of the guide opening. This ensures that the blow-out nozzles are always positioned at an optimal distance from the produced film tube, regardless of its diameter.

The diameter of the guide opening is the largest possible diameter of an imaginary circle within the adjustable guide rollers.

The nozzle section can be arranged, relative to the longitudinal axis, at least partially radially outside the guide roller. The nozzle section can be arranged completely radially outside the guide roller. Alternatively, it is also conceivable that the nozzle section is partially arranged in axial overlap with the guide roller in addition to the radial overlap. This means that the nozzle section at least partially covers or overlaps the guide roller when viewed in an axial direction. This can be the case on one side of the guide roller, relative to the haul-off direction, or on both sides of the guide roller. This means that the nozzle section has at least one section that is arranged upstream and/or downstream of the guide roller in axial overlap with the latter.

By axially overlapping the nozzle section with the guide roller, it is possible to position the blow-out nozzle at a smaller distance from the film tube than without axial overlap and thus increase the cooling capacity.

In order to achieve the most compact design possible, it may be provided that the nozzle section has a maximum height in the direction parallel to the longitudinal axis, at least over the entire length of the blow-out nozzle, at least over 50% of the length of the blow-out nozzle or at least over 25% of the length of the blow-out nozzle, which corresponds at most to 2.0 times, 1.5 times, 1.25 times or 1.0 times the height of the guide roller. The nozzle section can have a variable height in the circumferential direction around the longitudinal axis, so that reference is made here to the maximum height in the circumferential direction.

In order to achieve the most compact design possible for the tempering device, the guide rollers can be arranged offset in height to one another in the circumferential direction of adjacent guide segments in the direction of the longitudinal axis and, at least when the diameter of the guide opening falls below a predetermined value, can at least partially cross one another in plan view in the direction of the longitudinal axis.

In order to achieve as compact a design as possible, it may be provided that the nozzle sections of the intersecting guide segments have a maximum height in the direction of the longitudinal axis, at least over an area in which the guide segments intersect or can intersect, which corresponds at most to 2.0 times, 1.5 times, 1.25 times or 1.0 times the height of the respective guide roller.

In particular, if the nozzle section overlaps axially with the guide roller, the blow-out nozzle can be designed in such a way that the tempering gas flows out at an angle of 90° to the longitudinal axis. However, it can be advantageous to design the blow-out nozzle in such a way that the tempering gas has at least one flow vector in and/or against the haul-off direction at an angle of less than 90°, less than 60° or less than 45° to the longitudinal axis. In particular, the at least one flow vector can be directed away from the guide roller in order to prevent the temperature control gas flow from being influenced by the guide roller or the film tube from being lifted off the guide roller.

The nozzle section can have several blow-out nozzles that are arranged next to each other in the circumferential direction and/or one behind the other in the axial direction, for example.

It may be provided that at least one of the blow-out nozzles is aligned in the haul-off direction and at least one other of the blow-out nozzles is aligned against the haul-off direction.

The nozzle section can be an integral part of one of the guide segments. It is also conceivable that the nozzle section is a separate component connected to the guide segment.

Each guide element can have several guide rollers.

Several nozzle sections can be assigned to each guide roller. It is also possible for several guide rollers to be assigned a common nozzle section.

The tempering device can have a frame on which the guide segments are adjustably hinged to set the diameter of the guide opening. The frame can be designed as a separate unit from the other system components of a blown film line.

The tempering device can be designed to heat and/or cool the film tube. For this purpose, the tempering device can have a cooling unit for cooling the tempering gas and/or a heating unit for heating the tempering gas.

To reduce or prevent the film from sticking together (blocking) when folding, the film tube can be post-cooled by means of the tempering device. This means that the blown film line can be operated at a higher output, i.e. at a higher haul-off speed of the film tube, without running the risk of the film tube being fed to the collapsing unit when it is too hot and there is a risk of blocking. The output rate, i.e. the amount of film produced per time, can therefore be increased. Furthermore, the use of additives in the plastic material to reduce the tendency to blocking can be reduced or possibly even avoided. In addition to cost savings, the reduction of additives can also have a positive effect on the service life of the extruder's screw or extruders. Additives to reduce the tendency to block usually include mineral fillers, which can result in increased wear of the extruder components, especially the screw.

To improve the flatness of the film tube, however, the film tube can be reheated by means of the tempering device to reduce uneven stress distributions in the molecular structure. This improves the flatness and evenness of the film tube.

A particular advantage here is that one and the same tempering device is equally suitable for cooling tubular films made of material that is sensitive to blocking and for heating tubular films made of material that is sensitive to flatness. This means that the tempering device does not have to be replaced when switching between blocking-sensitive material and flatness-sensitive material.

The tempering device can have at least two guide levels of guide segments arranged one above the other in the direction of the longitudinal axis and distributed around the longitudinal axis. The guide segments of the multiple guide levels can be arranged around the circumference in such a way that at least two guide segments are always arranged one above the other in the direction of the longitudinal axis. The guide segments can be arranged identically for each guide level so that the distance between the guide segments of two guide levels is identical. In practice, it has been shown that at least two guide levels of guide segments or two rollers arranged one above the other are advantageous for stable guidance of the film tube. The rollers do not necessarily have to be aligned axially to each other, although this is advantageous for a simple actuating mechanism of the guide segments.

The tempering device can have adjusting units by means of which the guide segments can be adjusted transversely to the longitudinal axis in such a way that the respective guide roller is moved centrally to the longitudinal axis. For this purpose, the tempering device can have a frame through which the film tube can be guided in the direction of the longitudinal axis. The adjusting units may each include a pivot arm pivotally attached to the frame, a carrier for the guide roller, wherein the carrier is pivotally connected to the pivot arm, and a coupling rod pivotally connected to the carrier. For this, at least one of the adjusting units comprises an actuating mechanism by means of which the coupling rod of the at least one adjusting unit is pivotally connected to the frame. This arrangement enables the guide rollers to be precisely centered on the film tube for every diameter of film tube with little construction effort. Details of such adjusting units are shown in WO 2020/244737 A1, the content of which is hereby incorporated by reference.

Furthermore, the object is achieved by a blown film line, wherein the blown film line comprises a blow head for ejecting a film tube of plasticized thermoplastic material in a haul-off direction along a longitudinal axis and a cooling gas ring in the haul-off direction downstream of the blow head, which forms a central opening for the passage of the plasticized film tube and which has at least one internal outlet nozzle for flowing cooling gas onto the film tube so that the film tube changes from a plastic to a solidified state at a frost line. The blown film line has a tempering device as described above, which is intended to be positioned downstream of the frost line.

The blown film line may further comprise a calibration basket downstream of the cooling gas ring having a plurality of calibration elements configured to enclose the film tube and form a calibration opening to guide the film tube, wherein the calibration elements are adjustable to set a diameter of the calibration opening. The tempering device can be arranged downstream of the calibrating basket and mounted to the calibrating basket or arranged as a separate element at an axial distance from it.

According to an exemplary embodiment, the blown film line comprises a collapsing unit downstream of the tempering device for folding the film tube. Here, an area between the tempering device and the collapsing unit is free of elements that influence the film tube.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a general view of a blown film line with a tempering device with a first embodiment of adjustment segments;

FIG. 2 is a top front view of the tempering device according to FIG. 1;

FIG. 3 is a perspective view of a second embodiment of an adjustment segment;

FIG. 4 is a top front view of the adjusting segment according to FIG. 3;

FIG. 5 is a schematic side view of the first embodiment of the adjustment segment according to FIG. 1;

FIG. 6 is a schematic side view of the second embodiment of the adjustment segment according to FIG. 3;

FIG. 7 is a schematic side view of a third embodiment of an adjustment segment; and

FIG. 8 is a schematic side view of a fourth embodiment of an adjustment segment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

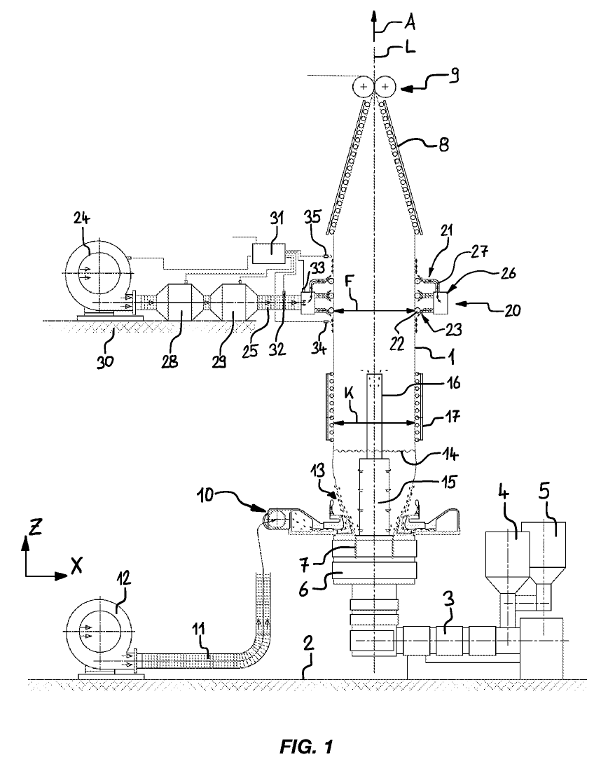

FIG. 1 is a side view partial in longitudinal section along a longitudinal axis L of a blown film line for the production of a film tube 1. To clarify the perspective, including the following Figures, a Cartesian coordinate system is shown, where the Z-axis is the vertical axis parallel to the longitudinal axis L and the two transverse axes X and Y span a horizontal plane. An extruder 3 stands on a machine foundation 2, on which two feed hoppers 4, 5 for thermoplastic material can be seen. A thermoplastic material fed in granular form via the feed hoppers 4, 5 is plasticized and homogenized by pressure and additional heating means in a screw of the extruder 3 and pressed into a blow head 6, adjoining the extruder 3, with vertical axis along the longitudinal axis L of the blown film line. The blow head 6 has a schematically represented ring nozzle 7 on its upper side, from which the expanding axially symmetrical film tube 1 emerges, initially still made of plasticized film material. After solidification of the film material, the film tube 1 substantially retains its diameter. The film tube 1 is pressed flat in a collapsing unit 8 and pulled off upwards by a haul-off unit 9. The flattened film tube 1 is then wound onto coils (not shown here). In the direction from the blow head 6 to the haul-off unit 9, the functional terms "in front of" and "downstream" are used in such a way that they mean "below" and "above" in spatial relationship.

Immediately above the blow head 6, a cooling gas ring 10 with a partially schematically represented gas supply line 11 is shown. The gas supply line 11 is connected to a blower 12 on the inlet side, via which cooling gas, usually air, is conveyed to the cooling gas ring 10. For this purpose, ambient air is drawn in by blower 12. Other cooling gases or cooling gas mixtures can also be used. The cooling gas ring 10 has internal outlet nozzles 13, from which the cooling gas flows out and flows onto the film tube 1, which is under increased internal pressure and is guided through a central opening 19 of the cooling gas ring 10, in a ring shape essentially parallel to the wall. The cooling gas flow from the blower 12 to the film tube 1 is symbolized by arrows. The film tube 1 plasticized in this area initially expands in diameter under the aforementioned excess pressure inside until it solidifies under the action of the cooling gas and assumes a constant diameter. The point of transition from the plasticized material to the hardened material is called the "frost line" and is designated 14. The frost line 14 does not have to be a clear line, but can extend over a limited area in the direction of the longitudinal axis L. To generate an internal overpressure, an internal cooling tower 15 is mounted centrally on the blow head 6, via which cooling gas is introduced into the interior of the film tube 1. The cooling gas introduced is discharged via a gas extraction pipe 16 in such a way that a defined internal pressure prevails.

Above, i.e., downstream of the frost line 14 in the haul-off direction A along the longitudinal axis L, there is a calibration basket 17, which contains calibration elements 18 with superimposed roller arrangements, which are essentially arranged in a ring around the film tube 1. In order to enable adaptation to film tubes 1 of different diameters, the roller arrangements are generally located on pivoting segments forming individual partial circumferences, by means of which the diameter of a calibration opening of the calibration basket 17, through which the film tube 1 is guided along the longitudinal axis L, can be changed. In cross-section, these segments form a polygon-shaped calibration opening. In the example shown, the calibration opening has a diameter K.

The cross-section of the still relatively warm film tube 1 is stabilized and guided by the calibration basket 17. The calibration basket 17 may be arranged in a height-adjustable manner relative to the blow head 6, in order to always be able to assume an optimum height position relative to the frost line 14.

A tempering device 20 is arranged downstream of the calibration basket 17 and is used to temper the film tube 1. The tempering device 20 has several guide segments 21 with guide rollers 22 and nozzle sections 23 arranged one above the other and distributed around the circumference of the film tube 1. The guide rollers 22 enclose the film tube 1 and form a guide opening with a diameter F. In this design example, the diameter F of the guide opening is identical to the diameter K of the calibration opening. The guide rollers 22 are used, among other things, to guide the film tube 1 centrally to the longitudinal axis L, so that the film tube 1 is guided centrally into the collapsing unit 8 in order to avoid creases or edge misalignment. As will be explained in detail below, the guide segments 21 are attached to adjustment segments that are adjustably hinged to a frame of the tempering device 20 in order to be able to vary the diameter F of the guide opening.

By means of the nozzle sections 23, a tempering gas is blown out diagonally upwards and downwards onto the film tube 1 in the haul-off direction. In principle, it is also conceivable that the tempering gas is blown out horizontally, i.e. in a plane perpendicular to the longitudinal axis L, against the film tube 1.

The diameters K and F are each defined as the largest possible diameter of an imaginary circle within the adjustable elements, i.e., the calibration elements 18 of the calibration basket 17 as well as the guide rollers 22 of the tempering device 20.

In the embodiment shown, the tempering device 20 is arranged at an axial distance from the calibration basket 17. However, it is also conceivable that the tempering device 20 is attached to the calibration basket 17 or is integrated with it to form a unit. A further tempering device can be arranged downstream of the calibrating basket 17 with integrated tempering device. Alternatively, it is also possible that the blown film line does not have a calibration basket.

A suction unit, not shown here, can be arranged downstream of the tempering device 20, through which the film tube 1 is guided centrally and with which the tempering gas is extracted. In order to remove as much tempering gas as possible before it enters the environment, a baffle plate arrangement with several baffle plates can also be provided downstream of the extraction unit. The baffle plates can be circular in shape, arranged transversely to the longitudinal axis L, and have a relatively small distance to the film tube 1 compared to the distance of the suction unit.

The nozzle sections 23 are supplied with tempering gas by a blower 24. The blower 24 draws in ambient air and directs it to the nozzle sections 23. A feed line 25, which connects the blower 24 to an air distributor ring 26 of the tempering device 20, is used for this purpose. The air distribution ring 26 is arranged in a ring around the film tube 1 and, in the example shown, around the guide segments 21 and is used to distribute the tempering gas evenly around the circumference. The air distribution ring 26 is fluidically connected to the individual nozzle sections 23 via supply lines 27.

A cooling unit in the form of an air cooler 28 and a heating unit in the form of an air heater 29 are arranged in the feed line 25, whereby external cooling or heating sources can also be used. This means that the tempering gas can be cooled or heated as required before it is fed to the nozzle sections 23. Alternatively, it is also possible that only the air cooler 28 or only the air heater 29 is provided. The order in which the blower 24, the air cooler 28 and the air heater 29 are arranged can be selected as required.

It should be noted that the blower 24, the air cooler 28 and the air heater 29 are shown at the level of the tempering device 20. For this purpose, these components can be arranged in a tower frame 30 (shown schematically here) of the blown film line. However, they can also stand on the machine foundation 2.

The blown film line also has a control unit 31, which is connected to the blower 24, the air cooler 28 and the air heater 29 in order to control them. The signals from several sensors are processed for the control system. The control unit 31 is equipped with a temperature sensor 32 in the feed line 25 for detecting the temperature of the tempering gas, with a pressure sensor 33 on the air distribution ring 26 for detecting the pressure in the air distribution ring 26, to a temperature sensor 34 upstream of the tempering device 20 for detecting the temperature of the film tube 1 before it enters the tempering device 20 and to a temperature sensor 35 downstream of the tempering device 20 for detecting the temperature of the film tube 1 after it exits the tempering device 20.

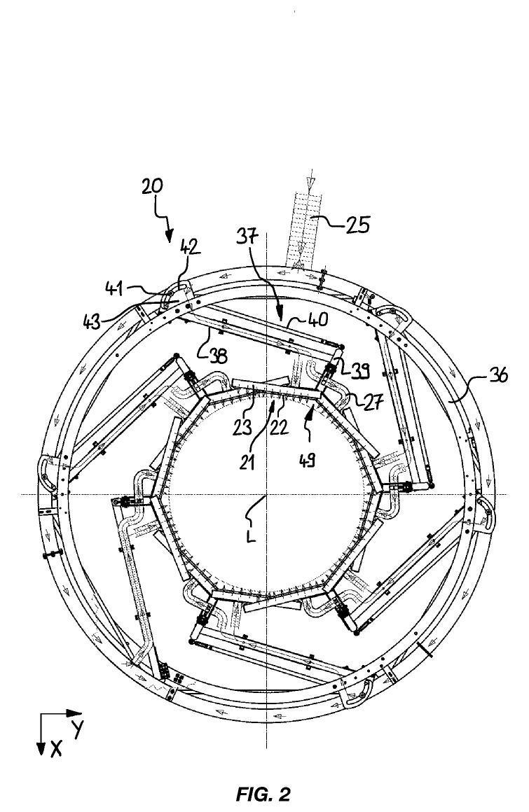

FIG. 2 shows a top view of the tempering device 20 according to FIG. 1, wherein components that correspond to components of the blown film line according to FIG. 1 are provided with the same reference signs and are described there.

The tempering device 20 has a frame 36 to which the movable elements described below are attached and which, if necessary, is arranged to be adjustable in height relative to the blow head 6. Furthermore, the air distributor ring 28 is attached to the frame 36.

The frame 36 forms a central passage through which the film tube 1 is guided parallel to the longitudinal axis L as shown in FIG. 1. There are six adjusting units 37 distributed around the circumference. The adjusting units 37 are used to adjust the adjustment segments 49 in a direction radial to the longitudinal axis L. The adjustment segments 49 support the guide segments 21 with the guide rollers 22 and the nozzle sections 23.

The adjusting units 37 each include a pivot arm 38 pivotally attached to the frame 36. In this case, the pivot arm 38 is pivotable about a pivot axis which is arranged parallel to the longitudinal axis L.

Furthermore, the adjusting units 37 each have a carrier 39, which is also a component of the respective adjustment segment 49 and, in the exemplary embodiment shown, carries six guide rollers 22 with nozzle sections 23. The guide rollers 22 are spaced apart in pairs in the direction of the longitudinal axis L and are arranged to overlap in a V-shape when viewed in the direction of the longitudinal axis L. Three of these pairs are arranged one above the other in the example shown, as can be seen in FIG. 1. Each pair of guide rollers 22 forms a guide level. Three guide rollers 22 of different guide levels are arranged one above the other and congruent to each other in the direction of the longitudinal axis L. The carrier 39 is pivotally connected to the pivot arm 38. In this case, the carrier 39 is pivotally connected to the pivot arm 38 about a pivot axis which is arranged parallel to the longitudinal axis L.

Further, the adjusting units 37 each include a coupling rod 40 pivotally connected to the carrier 39. Finally, the adjusting units 37 each comprise an actuating mechanism by means of which the coupling rod 40 is pivotally connected to the frame 36. The coupling rods 40 of the adjusting units 37 are each connected to the frame 36 in a pivoting and sliding manner via a coupling element (not shown). The coupling element is rotatably connected to the frame 36. The coupling rod 40 is slidably coupled to the coupling element. In addition, a cam follower 41 is attached to each of the coupling rods 40 and is guided along a guide 42 on the frame 36 for translational movement. In the embodiment shown, the guide 42 is a groove in a plate 43 that is fixedly attached to the frame 36. However, other guidance systems are also conceivable. The guide 42 is curvilinear in shape and adapted such that the carrier 39 is always aligned centrally with respect to the longitudinal axis L, irrespective of the distance from the longitudinal axis L or the film tube 1. This ensures precise centric alignment of the guide segment 21 and thus the guide rollers 22 relative to the film tube 1.

In principle, other actuating mechanisms, such as parallelogram arrangements, are also conceivable, whereby it should be ensured that the carriers 39 can be adjusted at least as far as possible radially to the longitudinal axis L.

Details of various adjusting units are shown in WO 2020/244737 A1, the contents of which are hereby incorporated by reference. Any of the versions of the adjusting units shown there can be used here.

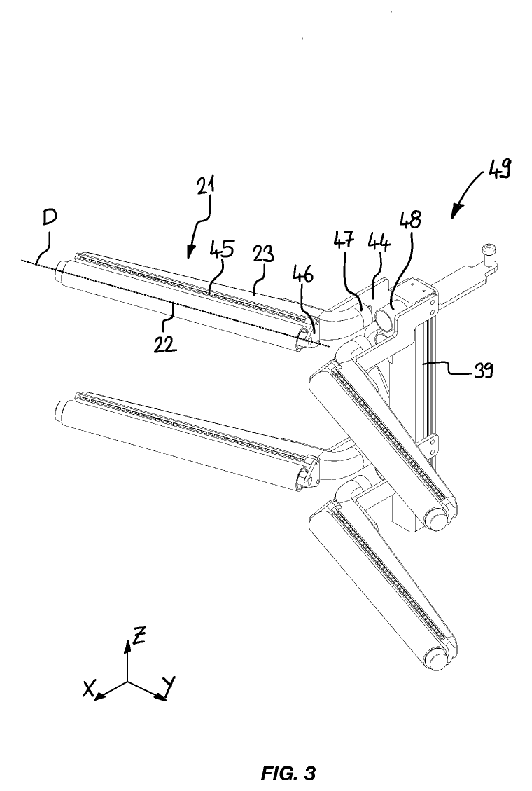

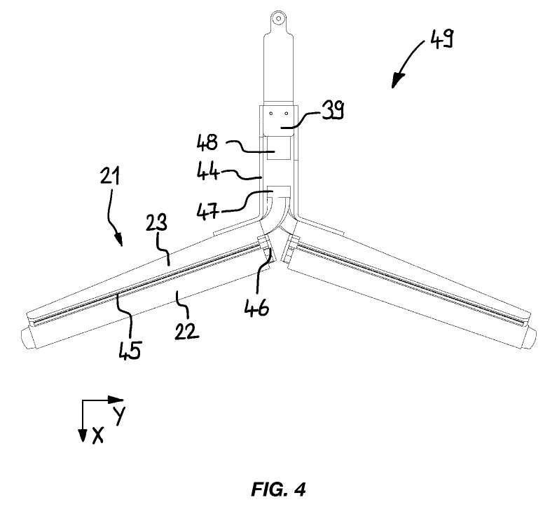

FIGS. 3 and 4 show different views of a second embodiment of an adjustment segment 49. Components that correspond to components of the first embodiment according to FIG. 2 are designated with the same reference signs and are described there.

In contrast to the first embodiment, the guide rollers 22 of the guide rollers 22 arranged in pairs in a V-shape are not arranged to overlap when viewed in the direction of the longitudinal axis L, but are arranged at a distance from one another, as can be seen in particular in FIG. 4. In addition, there are not three pairs of guide rollers 22 arranged one above the other, but two pairs.

Nozzle sections 23 are attached to the carrier 39 of the adjustment segment 49 via retaining plates 44. A guide roller 22 is mounted on each of the nozzle sections 23. It is also conceivable that several guide rollers 22 are rotatably mounted on each nozzle section 23. It is also possible that several nozzle sections 23 are provided along a guide roller 22.

The nozzle sections 23 are each tubular for the passage of tempering gas and are therefore an integral part of the adjustment segment 49. This means that no further element is provided, such as a support arm on which the nozzle section 23 is mounted as a separate component and the guide roller 22. However, such an embodiment is also possible.

In the following, one of the nozzle sections 23 is described as representative of all nozzle sections 23. The nozzle section 23 has a blow-out nozzle 45, which is slot-shaped and extends along the longitudinal extent of the guide roller 22. As will be explained later, the nozzle section 23 has a blow-out nozzle 45 directed in the haul-off direction and a blow-out nozzle (not visible here) directed against the haul-off direction.

The nozzle section 23 serves as a carrier element for the guide roller 22, which is connected to the nozzle section 23 via a bearing plate 46 and is mounted for rotation about an axis of rotation D. The nozzle section 23 can be made of plastic or metal, in one embodiment using a 3D printing process. By using 3D printing or a comparable additive manufacturing process, i.e. applying materials layer by layer, any geometry can be created for the channels of the tempering gas. This makes it possible, for example, to create special geometries that ensure uniform air distribution over the length of the air blow-out nozzle 45. In addition, the nozzle sections 23 can be manufactured monolithically, i.e. as a single piece.

Manufacturing the nozzle section 23 from plastic offers advantages in terms of weight, thermal insulation to reduce energy loss and low condensate formation on the surfaces when using cooled tempering gas. In particular, plastics that are temperature-resistant and resistant to substances emitted from the film tube, such as monomers, are used.

The nozzle section 23 has a connection piece 47, which is connected via a conduit, not shown here, to a connection 48 of the carrier 39 for supplying tempering gas. The carrier 39 is hollow and conducts tempering gas to the connections 48, with one connection 48 for each nozzle section 23.

In the exemplary embodiment shown, the guide rollers 22 of a pair are arranged offset in height relative to one another in the direction of the longitudinal axis L, which corresponds parallel to the Z-axis of the Cartesian coordinate system. In principle, however, the guide rollers 22 can also be arranged in a common plane in the direction of the longitudinal axis.

The blow-out nozzle 45 are each slightly shorter than the associated guide roller 22, as can be seen in particular in FIG. 4. In principle, the blow-out nozzles 45 should extend over a maximum length corresponding to the length of the respective guide roller 22, preferably having a length of 50% to 100% of the length of the guide roller 22. This ensures that the film tube is tempered precisely in the area where it comes into contact with the respective guide roller 22.

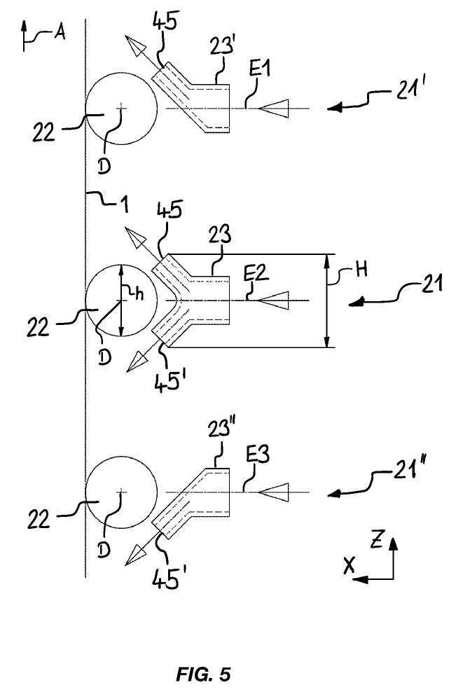

FIG. 5 shows a schematic side view of the first embodiment of an adjustment segment 49 according to FIG. 1, wherein components which correspond to components of the second embodiment according to FIG. 3 are provided with the same reference signs and are described there.

The guide segments 21, 21', 21'' with nozzle sections 23, 23', 23'' and the respective guide rollers 22 in relation to the film tube 1 are shown schematically for three guide levels E1, E2, E3. The nozzle section 23 of the second guide level E2 corresponds in its design to the nozzle section 23 of the guide segment 21 of the second embodiment of the adjustment segment 49 as shown in FIG. 3.

The nozzle section 23 has a blow-out nozzle 45 aligned in haul-off direction A and a blow-out nozzle 45' aligned in the opposite direction to haul-off direction A. Here, "aligned in haul-off direction A" means that the blow-out nozzle 45 is designed in such a way that the tempering gas has at least one flow vector that is aligned in haul-off direction A at an angle of less than 90° to the longitudinal axis L. "Against the haul-off direction" means that the blow-out nozzle 45' is designed in such a way that the tempering gas has at least one flow vector against the haul-off direction A at an angle of less than 90° to the longitudinal axis L. In principle, however, it is also conceivable that the nozzle section 23 is designed in such a way that at least one blow-out nozzle is designed in such a way that the tempering gas flows out at an angle of 90° to the longitudinal axis.

In relation to the longitudinal axis L, the nozzle section 23 is partially arranged in radial overlap with the guide roller 22 of the second guide level E2. Part of the nozzle section 23 protrudes over the guide roller 22 in the haul-off direction A and part against the haul-off direction A. In principle, the nozzle section 23 can also be designed in such a way that it is completely radially overlapping with the guide roller 22.

In the exemplary embodiment shown, the nozzle section 23 has a maximum height H in the direction of the longitudinal axis L, which is greater than the height h of the guide roller 22 in the direction of the longitudinal axis L.

In the exemplary embodiment shown, the nozzle section 23 has a V-shaped profile in the direction of the guide roller 22, which slightly surrounds the guide roller 22. This means that the nozzle section 23, in relation to the longitudinal axis L, is also partially arranged in radial overlap with the guide roller 22. It is also conceivable that no axial overlap is provided. The axial overlap can also be greater than shown in the example shown. For example, the blow-out nozzles 45, 45' can be arranged between the axis of rotation D of the guide roller and the film tube 1 when viewed in the direction of the longitudinal axis L.

In contrast to the nozzle section of the second guide level E2, the nozzle section 23' of the first guide level E1 has only one blow-out nozzle 45, which is aligned in the haul-off direction A. The nozzle section 23'' of the third guide level E3 has only one blow-out nozzle 45', which is aligned in the opposite direction to the haul-off direction A.

Thus, the nozzle section 23 of the middle second guide level E2 blows out both upwards and downwards or in the haul-off direction A and against the haul-off direction A. The nozzle section 23' of the first guide level 1, on the other hand, only discharges upwards in the haul-off direction A, whereas the nozzle section 23'' of the third guide level E3 only discharges downwards in the opposite direction to the haul-off direction A.

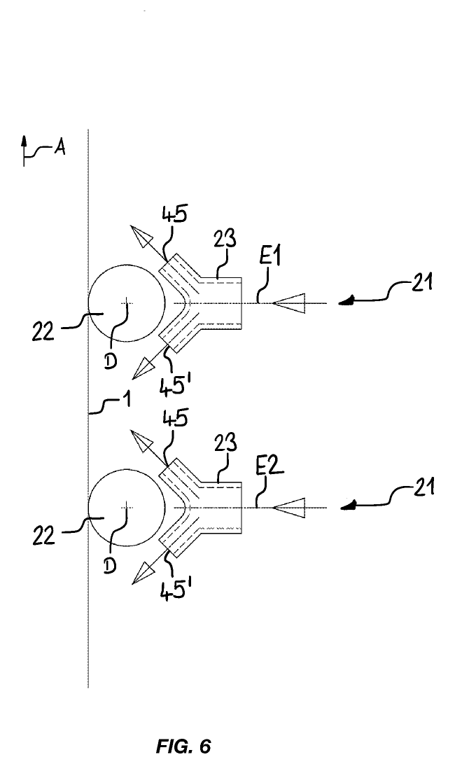

FIG. 6 shows a schematic side view of the second embodiment of the adjustment segment 49 according to FIG. 3, wherein components which correspond to components of the first embodiment according to FIG. 1 are provided with the same reference signs and are described there.

In contrast to the first embodiment, the second embodiment of the adjustment segment 49 has two guide levels E1, E2. The guide segments 21 of the two guide levels E1, E2 are identical and correspond to those of the second level of the first embodiment. Both nozzle sections 23 thus blow out both upwards and downwards or in the haul-off direction A and against the haul-off direction A.

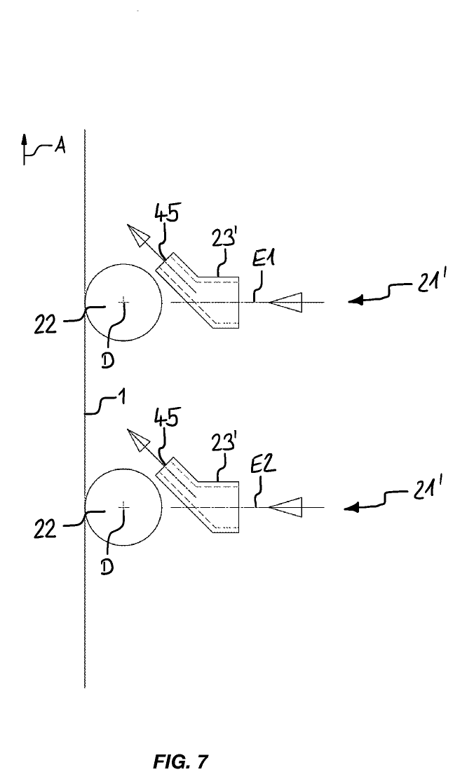

FIG. 7 shows a schematic side view of a third embodiment of an adjustment segment 49, wherein components that correspond to components of the first two embodiments are provided with the same reference signs and are described there.

Like the second embodiment, the third embodiment of the adjustment segment 49 has two guide levels E1, E2. The guide segments 21' of the two guide levels E1, E2 are identical and correspond to those of the first level of the first embodiment. Both nozzle sections 23 thus blow out upwards in haul-off direction A. It is also conceivable that the two guide elements are designed identically to the guide element of the third level of the first embodiment and thus blow out downwards in the opposite direction to the haul-off direction A.

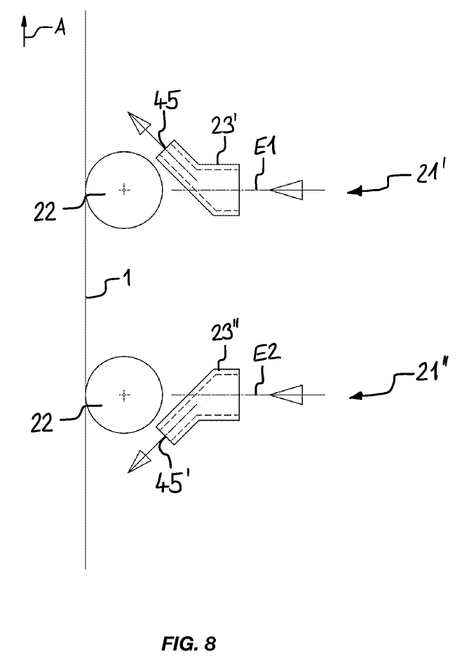

FIG. 8 shows a schematic side view of a fourth embodiment of an adjustment segment 49, wherein components that correspond to components of the first three embodiments are provided with the same reference signs and are described there.

Like the second embodiment, the fourth embodiment of the adjustment segment 49 has two guide levels E1, E2. The guide segment 21' of the first guide level E1 is designed identically to the guide segment of the first level of the first embodiment and thus blows out upwards in the haul-off direction A. The guide segment 21'' of the second guide level E2 is designed identically to the guide segment of the third level of the first embodiment and thus blows out downwards in the opposite direction to the haul-off direction A.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A tempering device for tempering of a film tube extruded in a haul-off direction above a frost line, the tempering device comprising:
several guide segments which are distributed around a longitudinal axis arranged parallel to the haul-off direction of the film tube and form a central guide opening for guiding the film tube along the longitudinal axis, wherein the guide segments are adjustable transversely to the longitudinal axis for adjusting a diameter of the guide opening;
a guide roller for each guide segment, wherein the guide roller is adjustable together with the guide segment and is configured to guide the extruded film tube; and
a nozzle section associated with the guide roller, which is adjustable together with the guide segment,
wherein the nozzle section has a blow-out nozzle which is designed to blow out a tempering gas in the direction towards the longitudinal axis, and
wherein the nozzle section is arranged, relative to the longitudinal axis, in at least partial radial overlap with the guide roller.

2. The tempering device according to claim 1, wherein the nozzle section is arranged, relative to the longitudinal axis, at least partially radially outside the guide roller.

3. The tempering device according to claim 1, wherein the nozzle section has a maximum height in the direction of the longitudinal axis over an entire length of the blow-out nozzle, at least over 50% of the length of the blow-out nozzle or at least over 25% of the length of the blow-out nozzle, which corresponds at most to 2.0 times, 1.5 times, 1.25 times or 1.0 times the height of the guide roller.

4. The tempering device according to claim 1, wherein the guide rollers of adjacent guide segments are arranged offset in height relative to one another in the direction of the longitudinal axis and, at least when the guide opening falls below a predetermined diameter, cross one another at least partially in the direction of the longitudinal axis.

5. The tempering device according to claim 4, wherein the nozzle sections of intersecting guide segments have a maximum height in the direction of the longitudinal axis, at least over an area in which the guide segments can intersect, which corresponds at most to 2.0 times, 1.5 times, 1.25 times or 1.0 times the height of the respective guide roller.

6. The tempering device according to claim 1, wherein the blow-out nozzle is configured such that the tempering gas has at least one flow vector in and/or against the haul-off direction at an angle of less than 90°, less than 60° or less than 45° to the longitudinal axis.

7. The tempering device according to claim 1, wherein the nozzle section has a plurality of blow-out nozzles.

8. The tempering device according to claim 1, wherein the nozzle sections are each an integral part of the respective guide segment.

9. The tempering device according to claim 1, wherein each guide segment has several guide rollers.

10. The tempering device according to claim 9, wherein a common nozzle section is assigned to several guide rollers of a guide segment.

11. The tempering device according to claim 1, wherein the tempering device has a cooling unit for cooling the tempering gas and/or a heating unit for heating the tempering gas.

12. The tempering device according to claim 1, wherein the tempering device has at least two guide levels of guide segments which are arranged one above the other in the direction of the longitudinal axis and are distributed around the longitudinal axis.

13. The tempering device according to claim 12, wherein at least two guide segments are always arranged one above the other in the direction of the longitudinal axis, distributed over a circumference.

14. The tempering device according to claim 1, wherein the tempering device comprises adjusting units by means of which the guide segments can be adjusted transversely to the longitudinal axis in such a way that the respective guide roller is moved centrally to the longitudinal axis.

15. A blown film line comprising:
a blow head for ejecting a film tube of plasticized thermoplastic material in a haul-off direction along a longitudinal axis;
a cooling gas ring in the haul-off direction downstream of the blow head, which forms a central opening for passage of the plasticized film tube and which has at least one internal outlet nozzle for blowing cooling gas onto the film tube, so that the film tube changes from a plastic to a solidified state at a frost line; and
the tempering device according to claim 1 to be arranged downstream of the frost line.

16. The blown film line according to claim 15,
wherein a calibration basket arranged downstream of the cooling gas ring, having a plurality of calibration elements which are configured to enclose the film tube and form a calibration opening in order to guide the film tube, the calibration elements being adjustable for setting a diameter of the calibration opening, and
wherein the tempering device is arranged downstream of the calibrating basket and is mounted to the calibrating basket or is arranged at an axial distance therefrom.

17. The blown film line according to claim 15, wherein the blown film line comprises a collapsing unit downstream of the tempering device for collapsing the film tube, and
wherein an area between the tempering device and the collapsing unit is free of elements influencing the film tube.
